(19) United States
(12) Patent Application Publication
(10) Pub. No.: US 2011/0206588 A1
(43) Pub. Date: Aug. 25, 2011

(54) METHOD AND APPARATUS FOR REMOVING AMMONIA FROM A GAS STREAM

(76) Inventor: Klaus S. Lackner, Dobbs Ferry, NY (US)

(21) Appl. No.: 13/058,802

(22) PCT Filed: Aug. 11, 2009
(86) PCT No.: PCT/US09/53461

§ 371 Date: May 6, 2011

Related U.S. Application Data
(60) Provisional application No. 61/087,982, filed on Aug. 11, 2008.

(51) Int. Cl. B01D 53/58

(52) U.S. Cl. 423/237

(57) ABSTRACT

The present disclosure provides a method for removing ammonia from a gas stream, comprising contacting the gas stream with a substrate having anions carried on a surface thereof, whereupon ammonia in the gas stream attaches to the substrate by reacting with the anions.

The present disclosure relates to removal of selected gases from air. The disclosure has particular utility for the extraction of ammonia (NH₃) from air and will be described in connection with such utilities, although other utilities are contemplated.

Ammonia is a harmful pollutant that is commonly produced in livestock facilities from the breakdown of animal waste. Undigested feed protein and wasted feed are additional sources of ammonia in livestock systems.

Strategies for reducing ammonia emissions from animal facilities and other sources include preventing ammonia formation and volatilization and controlling the transmission of ammonia. These strategies include the use of filtration systems, impermeable and semi-permeable barriers, and dietary manipulation. See, for example, U.S. Pat. No. 5,009,678.

While solutions are plentiful, none have proven to be effective in reducing the amount of ammonia emitted without incurring substantial costs. Many of the prior art solutions require large amounts of chemical solutions to treat the waste and/or require large amounts of energy to drive air through packed towers or wet scrubbers.

The present disclosure improves on the prior art by providing an ammonia (NH₃) capture process which comprises bringing a gas stream in contact with a cationic resin, wetting the resin with water, collecting water vapor and NH₃ from the resin to extract the NH₃ from the gas stream. The captured NH₃ may subsequently be released by subjecting the resin to moisture, e.g. water vapor or water. The present disclosure provides several substrate materials that improve the efficiency of the capture of the NH₃ on the resin, and subsequent release of the carbon dioxide into the water.

In a primary example, the present disclosure provides improved substrates that facilitate the capture and release of ammonia (NH₃) using a humidity swing. A substrate that can hold cations on its surface provides an improved NH₃ sorbent.

In co-pending application U.S. patent appln. Ser. No. 12/265,556 filed Nov. 5, 2008, incorporated by reference herein and assigned to a common assignee, there is described a carbon dioxide (CO₂) capture process which comprises bringing a gas stream in contact with a resin, wetting the resin with water vapor or liquid water, collecting water vapor and carbon dioxide from the resin to extract the CO₂ from the gas stream, and separating the carbon dioxide from the water vapor. The reference provides several substrate materials that improve the efficiency of the capture of the carbon dioxide on the resin, and release of the carbon dioxide into the water. These materials have been proven suitable to capture CO₂ and other acid gases from air. The present disclosure provides similar materials that have been configured to capture ammonia (NH₃) and other basic gases from air.

Similar to applications for the capture of CO₂, a solid substrate must have a large surface area exposed to the gas stream and it needs to be able to temporarily hold on to NH₃ molecules by some mechanism. The mechanism used by the present disclosure is based on the binding energy between positive ions and negative ions.

The aforementioned application Ser. No. 12/265,556 describes a material for capturing CO₂, comprising a matrix loaded with attached positive ions that will hold on to negative ions even if the negative ions are individually mobile. Conversely, the capture of NH₃ requires a matrix loaded with negative ions, i.e., cationic materials, that will hold on to positive ions even if the positive ions are individually mobile. In this configuration, the positive ions are mobile in water. As these ions “dissolve” into the water, their dynamics will be similar to those of the same ions in a dissolved salt. However, the negative charge on the substrate must be neutralized by some positive ions.

The initial preparation of a substrate could use any positive ion to satisfy charge balance, but hydrogen ions are preferred. The spacing of the charged particles attached to the substrate will have a substantial effect on the stability of the material. Hydrogen ions attached to the surface can react with NH₃ to form ammonium ions (NH₄+).

Such a material exposed to moisture, e.g. would then convert the ammonium ions NH₄+ into aqueous ammonia (containing ammonium and hydroxide ions (NH₄+) (OH—) and ammonia. Thus, when wetted, the material will release a large amount of ammonia.

The water carrying capacity of the substrate should be minimized, thereby limiting the amount of water that needs to be removed before the surface can pick up NH₃ again. This feature is inherently in conflict with other desirable features, namely, the substrate should be highly porous and covered with ions that attract polar molecules, which necessarily includes water molecules. Therefore, optimization is required.

A water swing works with any substrate that has the properties laid out above. In the presence of water the ions that are dissolved into the water will achieve an equilibrium state that is similar to what one would expect in an aqueous solution that is in equilibrium with a partial pressure of NH₃ of a certain level.

Another option is to use a thermal swing. In this example, the sorbent material is heated to release the NH₃ and regenerate the acidic form of the cationic exchange resin. By way of example the operation of a thermal swing in the capture of carbon dioxide in co-pending PCT application PCT/US07/084880, incorporated by reference herein.

For example, using thermal swing as a regeneration mechanism, at or around a temperature of about 40° C., NH₃ gas begins to be released by the resin and emitted therefrom. The release of NH₃ at this temperature is a useful feature of strong-based ion exchange resins which may be used in a NH₃ extraction process which typically lose all or a portion of their efficacy at the temperatures required to free bound NH₃. Since the preferred operating temperature is in the range of about 40° C. to 95° C., a weak based ion exchange resin is required. It is the weakly bound nature of the NH₃/weak base ion exchange resin connection which allows the successful separation of NH₃ with the resin at the preferred temperature of 40° C.-95° C. which is below the recommended maximum temperature of this resin type (typically) 100°.

Various exchange resins are available commercially and advantageously may be used in the present invention. Particularly preferred are ion exchange resins such as Purolite® A830 available from the Purolite Company of Bala Cynwyd, Pa., Amberlite® IRA67 available from Rohm & Haas, Philadelphia, Pa., and Diaion® 20 and Diaion® 30 available from Mitsubishi Chemical Corporation, Tokyo, Japan. However, other commercially available ion exchange resins advantageously may be employed in accordance with the invention.

It should be emphasized that the above-described embodiments of the present device and process, particularly, and “preferred” embodiments, are merely possible examples of implementations and merely set forth for a clear understanding of the principles of the disclosure. Many different embodiments of the method and apparatus for extracting carbon dioxide from air described herein may be designed and/or fabricated without departing from the spirit and scope of the disclosure. All these and other such modifications and variations are intended to be included herein within the scope of this disclosure and protected by the following claims. Therefore the scope of the disclosure is not intended to be limited except as indicated in the appended claims.

1. A method for removing ammonia from a gas stream, comprising
placing said gas stream in contact with substrate carrying a cationic resin, whereupon ammonia from said gas stream attaches to said substrate by reacting with said cationic resin.

2. The method as recited in claim 1, wherein said cationic resin includes hydrogen ions attached to a surface of the cationic resin.

3. The method as recited in claim 1, wherein said substrate is formed by coating said cationic resin onto a substrate material.

4. The method as recited in claim 1, wherein said substrate comprises a porous material carrying said cationic resin.

5. The method as recited in claim 1, and further including the step of subsequently releasing the ammonia from the substrate by exposing the substrate to moisture.

6. The method as recited in claim 5, wherein the substrate is subjected to liquid water.

7. The method as recited in claim 1, and further including the step of subsequently releasing the removed ammonia from the substrate by heating the substrate.

8. A method for capturing and removing ammonia from a gas stream, comprising
placing said gas stream in contact with a substrate having an exposed cationic material thereon, whereupon ammonia from said gas stream becomes attached to said substrate by reacting with the cations of said cationic material to form ammonium.

9. The method as recited in claim 8, and further including the step of releasing the captured ammonia from said substrate by washing the substrate with water.

10. The method as recited in claim 8, including the step of releasing the captured ammonia from said substrate by exposing the substrate to humidity.

11. The method as recited in claim 8, and further including the step of releasing the captured ammonia from said substrate by heating the substrate.

12. A method for removing ammonia from humid air, comprising
bringing the humid air in contact with a material having a surface carrying available hydrogen ions, wherein ammonia from the humid air becomes attached to the surface of the material by reacting with the hydrogen ions.

13. The method as recited in claim 12, wherein the hydrogen ions and the ammonia react to form ammonium.
